(19) United States
(12) Patent Application Publication
(10) Pub. No.: US 2023/0082814 A1
(43) Pub. Date: Mar. 16, 2023

(54) SYSTEMS AND METHODS FOR MONITORING THERAPEUTIC SAMPLES USING SCHLIEREN

(71) Applicant: Purdue Research Foundation, West Lafayette, IN (US)

(72) Inventors: Arezoo M. Ardekani, West Lafayette, IN (US); Rishabh Vishnu More, West Lafayette, IN (US); Andres Barrio-Zhang, West Lafayette, IN (US); Sadegh Dabiri, West Lafayette, IN (US)

(21) Appl. No.: 17/941,127

(22) Filed: Sep. 9, 2022

Related U.S. Application Data
(60) Provisional application No. 63/242,806, filed on Sep. 10, 2021.

(51) Int. Cl. G01N 21/45; B01L 3/00

(52) U.S. Cl. CPC G01N 21/455; B01L 3/502715; B01L 2300/0654; G01N 2201/127; G06T 7/0012

(57) ABSTRACT

A system includes a light source, a first lens, a second lens, a third lens, a beam splitter, a first image collection device, and a second image collection device. The first lens is configured to collimate a light beam and to direct the collimated light beam through a test sample. The beam splitter is configured to split the light beam from the test sample and to transmit a first portion of the light beam toward the second lens and reflect a second portion of the light beam toward the third lens. The first image collection device is positioned adjacent to a first obstruction and configured to record an obstructed first image formed by the first portion of the light beam. The second image collection device is positioned adjacent to a second obstruction and configured to record an obstructed second image formed by the second portion of the light beam.

### CROSS-REFERENCE TO RELATED APPLICATIONS

This application is related to and claims the priority benefit of U.S. Provisional Application No. 63/242,806, entitled “System for Monitoring Heterogeneity in Therapeutic Samples Using Schlieren,” filed Sep. 10, 2021, the contents of which are hereby incorporated by reference in their entirety into the present disclosure.

### TECHNICAL FIELD

The present application relates to therapeutics, and specifically to Schlieren-based systems and methods for analyzing and monitoring heterogeneity in therapeutic samples.

### BACKGROUND

This section introduces aspects that may help facilitate a better understanding of the disclosure. Accordingly, these statements are to be read in this light and are not to be understood as admissions about what is or is not prior art.

Antigens, antibodies, and therapeutic proteins are widely used in biotechnology and pharmaceutical applications. The importance of vaccines in fighting various diseases cannot be overstated. Over the past decade, the scientific community and the vaccine industry had to quickly respond with efficient vaccines against the epidemics of H1N1 influenza, Ebola, Zika, and SARS-CoV-2 (COVID-19). Monoclonal antibodies (mABs) have revolutionized the treatment of rheumatologic, oncologic, and infectious diseases. Promising trials of these agents and vaccines against COVID-19 have led to emergency use authorization in the United States. Still, ramping up the manufacturing, improving storage life, and quality control testing of mABs and vaccine products pose many challenges that need to be answered for their affordable and faster development timeline.

The presence of a multi-billion-dollar market for mABs, vaccines, and other therapeutic proteins has forced many technological advancements in their manufacturing processes. However, these pharmaceutical solutions are likely to undergo many physical and chemical processes, making them unstable or changing their molecular structures. Once the final formulation is achieved, the product must be stabilized so that it can be transported and properly stored upon delivery. Since the production, isolation, purification, and storage of these proteins are costly, the solutions are usually stabilized at high concentrations to be stored with a minimum loss of activity.

The most popular and effective storage method is to freeze the samples. Thus, freezing and thawing are two relevant physical processes that these samples often undergo from production to final use. Freezing of the product has multiple benefits. It reduces the risk of microbial growth, increases product stability, and eliminates foaming and agitation during transportation. Freezing can even occur accidentally during refrigerated storage. Therefore, freeze-thawing is a crucial part of the manufacturing of antigens and monoclonal antibodies. Exposure to temperature variations during transport, handling, and freeze-thawing of therapeutic samples may lead to undesirable instabilities.

Protein denaturation induced at low temperatures is linked to multiple factors, including crystallization engendered buffer pH drop or rise, cryoconcentration of solute molecules, and emergence of water-ice interface. These stresses can lead to loss of colloidal and/or conformational stability of the proteins. Hence, it is not surprising that the number of freeze-thaw cycles has an immediate effect on the aggregation and concentration of mAbs. Bio-pharmaceutical samples and reference standards are prepared using proteins, polysaccharides, protein-polysaccharide conjugates or viruses, and virus-like particles. Freeze-thaw can induce internal stresses in the sample, leading to protein aggregation and result in heterogeneities in the concentration. Concentration gradients form within the container when large protein molecules are initially excluded from the ice during freezing. This local increase in the concentration of the biomolecules during freezing can induce irreversible changes making the biomolecules difficult to disperse homogeneously after thawing. Hence, the freeze-thawing process can result in variable and inaccurate test results if the samples or references are not uniformly mixed and re-suspended prior to sampling. Reducing the aggregation and heterogeneity, in other words, having a properly mixed solution, is one of the main goals of the biotechnology and pharmaceutical industry. To achieve this goal, concentration variations need to be detected and monitored quickly and reliably.

Heterogeneity which is defined as the spatial variations in the concentration, composition, and thermodynamic phase of a sample, have previously been detected in bio-pharmaceutical samples using thermogravimetric analyses, calorimetric analyses, X-ray diffractometry, and infrared spectroscopy. In some cases, the composition variations in frozen samples have also been studied using freeze-fracture and scanning electron microscopy techniques. If the variations are large enough, just transmitting light is enough to visualize these heterogeneities in frozen samples. However, if these variations are very small (often called micro-heterogeneity), advanced techniques based on Raman spectroscopy, such as counter-gradient freezing Raman microscopy, have been developed to investigate them. However, these techniques need sophisticated equipment, making them expensive. These would be costly to install for quick visual detection of heterogeneities, for example, on a production line or right before testing and analysis of the therapeutic solutions or for quality control purposes. Hence, there is a need for an in situ, fast and portable method to detect and quantify concentration heterogeneities in pharmaceutical samples during the freeze-thaw process or otherwise.

### SUMMARY

Aspects of this disclosure describe Schlieren-based systems and methods for analyzing and monitoring heterogeneity in therapeutic samples.

In some aspects of the present disclosure, such a system can include a light source, a first lens, a second lens, a third lens, a beam splitter, a first image collection device, and a second image collection device. The light source can be configured to emit a light beam. The first lens can be configured to collimate the light beam and to direct the collimated light beam through a test sample. The beam splitter can be configured to split the light beam from the test sample and to transmit a first portion of the light beam toward the second lens and reflect a second portion of the light beam toward the third lens. The first image collection device can be positioned adjacent to a first obstruction and can be configured to record a first image formed by the first portion of the light beam. Particularly, the first obstruction can be configured to partially obstruct the first portion before the first portion is recorded by the first image collection device. Further, the second image collection device can be positioned adjacent to a second obstruction and configured to record a second image formed by the second portion of the light beam. The second obstruction can also be configured to partially obstruct the second portion before the second portion is recorded by the second image collection device.

Aspects of the present disclosure also provide methods of analyzing a therapeutic test sample with an optical system. The methods can include one or more various acts, such as generating a light beam from a light source; directing the light beam through a first lens and through a therapeutic test sample; transferring a first portion of light from the test sample through a second lens; obstructing, at least partially, the first portion of the light from the second lens; and recording, via a first image collection device, a first image from the at least partially obstructed first portion of light. Further acts can include one or more of transferring a second portion of light from the test sample through a third lens; obstructing, at least partially, the second portion of the light from the third lens; and recording, via a second image collection device, a second image from the at least partially obstructed second portion of light.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic diagram of deflection of light rays due to optical heterogeneities;

FIG. 2 depicts a schematic diagram of one exemplary Schlieren-based system architecture;

FIG. 3A depicts experimental output diagrams showing the intensity variation in a weak lens along the diameter of the weak lens (shown in the dashed line) when the knife-edge of the system of FIG. 2 is disposed vertically;

FIG. 3B depicts experimental output diagrams showing the intensity variation in a weak lens along the diameter of the weak lens (shown in the dashed line) when the knife-edge of the system of FIG. 2 is disposed horizontally;

FIG. 4A depicts a graphical representation of the refractive index (n) versus the concentration (c) for BSA Formulation A, the dotted line showing the linear fit to the data with the corresponding equation and R² value of the fit;

FIG. 4B depicts a graphical representation of the refractive index (n) versus the concentration (c) for BSA Formulation B, the dotted line showing the linear fit to the data with the corresponding equation and R² value of the fit;

FIG. 4C depicts a graphical representation of the refractive index (n) versus the concentration (c) for BSA Formulation C, the dotted line showing the linear fit to the data with the corresponding equation and R² value of the fit;

FIG. 4D depicts a graphical representation of the refractive index (n) versus the concentration (c) for BSA Formulation D, the dotted line showing the linear fit to the data with the corresponding equation and R² value of the fit;

FIG. 5A depicts a graphical representation of the refractive index (n) versus the concentration (c) for IgG Formulation E, the dotted line showing the linear fit to the data with the corresponding equation and R² value of the fit;

FIG. 5B depicts a graphical representation of the refractive index (n) versus the concentration (c) for IgG Formulation F, the dotted line showing the linear fit to the data with the corresponding equation and R² value of the fit;

FIG. 5C depicts a graphical representation of the refractive index (n) versus the concentration (c) for IgG Formulation G, the dotted line showing the linear fit to the data with the corresponding equation and R² value of the fit;

FIG. 5D depicts a graphical representation of the refractive index (n) versus the concentration (c) for IgG Formulation H, the dotted line showing the linear fit to the data with the corresponding equation and R² value of the fit;

FIG. 6A depicts a schematic of an exemplary cuvette filling process using a syringe pump and capillary tube filling of a light solution;

FIG. 6B depicts a schematic of an exemplary cuvette filling process with a syringe pump and capillary tube filling of a dense solution relative to the light solution of FIG. 6A;

FIG. 7A depicts a graphical representation of a calculated deflection angle over a line of interrogation for 50% v/v glycerol, the insets showing the interface at the initial time (left) and final time (right);

FIG. 7B depicts a graphical representation of a calculated deflection angle over a line of interrogation for 1% w/v salt in water, the insets showing the interface at the initial time (left) and final time (right);

FIG. 8A depicts a graphical representation of measurements for coefficient B(t) vs time, t, for 50% v/v glycerol, the dashed lines showing a linear square fit to B(t) vs. t data;

FIG. 8B depicts a graphical representation of measurements for coefficient B(t) vs time, t, for 1% w/v salt in water, the dashed lines showing a linear square fit to B(t) vs. t data;

FIGS. 9A-H depict photographical output diagrams of vertical concentration gradients taken during the thawing of 5 μg/ml of formulation F;

FIGS. 10A-H depict photographical output diagrams of horizontal concentration gradients during the thawing 5 μg/ml of formulation F;

FIGS. 11A-H depict photographical output diagrams of thawing distilled water;

FIG. 12A depicts a photographical output diagram of concentration gradients in a thawing sample of formulation F at t=120 seconds, the sample with concentration=5 μg/ml and showing vertical gradients; and

FIG. 12B depicts a photographical output diagram of concentration gradients in a thawing sample of formulation F at t=120 seconds, the sample with concentration=50 μg/ml and showing vertical gradients.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

As described above, heterogeneity detection is essential in making sure samples of mABs, vaccines, and other therapeutic proteins are properly mixed before using them in a desired application. Such a technique should not only visualize the heterogeneity for qualitative inspections but also be capable of accurately quantifying the concentration gradients. This technique can then be utilized to investigate the strength of heterogeneity for different proteins and buffers under similar freeze-thaw conditions for a quantitative comparison. Furthermore, a quick visualization tool can help determine optimum freeze-thaw conditions for therapeutic matrices, thus saving significant time and money in their development and quality control. It is also beneficial if the sensitivity of the tool is independent of the exact components of the therapeutic samples so that it can be utilized for any transparent sample or vaccine formulation. As described in the present disclosure, a Schlieren-based tool and an associated method are capable of performing all the above tasks and quantifying concentration gradients. The Schlieren-based method is advantageous for a gamut of therapeutic samples such as antibodies, antigens, proteins, polysaccharides, protein-polysaccharide conjugates, or viruses and virus-like particles, and vaccine products, among others.

Despite its simplicity and versatility, a Schlieren-based visualization technique for detecting heterogeneities in therapeutic samples has not been explored before. Such a Schlieren-based technique is advantageous for studying the impact of freezing, thawing, and mixing conditions on the homogeneity of therapeutic samples (e.g., monoclonal antibodies or other proteins) or vaccines. This is especially instrumental in the fight against COVID-19, a severe acute respiratory syndrome coronavirus 2 (SARS-CoV-2), which resulted in a global pandemic designation in 2020. A fast, portable, and reliable technique to detect sample heterogeneities can speed up the timeline for vaccine production by providing an efficient way to control sample mixing.

To this end, a portable system based on the Schlieren principle is described herein to evaluate the homogeneity of biological samples within a container. The refractive index (n) of a material is a unit-less number that describes the bending of light rays as it passes through that material. The refractive index is strongly dependent on the concentration of the solution. Thus, changes in the refractive index due to even minute changes in the concentration of buffers, salts, or biomolecules lead to significant optical intensity variations within the samples. The described Schlieren system captures these optical intensity variations. The use of refractive index measurements and the Schlieren method are described as tools for evaluating sample and reference standard homogeneity. These methods can be used to quantify the effects of different buffers and/or freeze-thaw conditions on the heterogeneity in therapeutic samples. Thus, the described visualization tool can be utilized for analytic studies in order to find optimum storage conditions for a variety of samples/matrices irrespective of their specific composition. Next, the basic principles behind the Schlieren method are discussed and the Schlieren tool elaborated on before reviewing validations and heterogeneity visualizations in the thawing of sample therapeutical solutions.

### I. SCHLIEREN PRINCIPLES

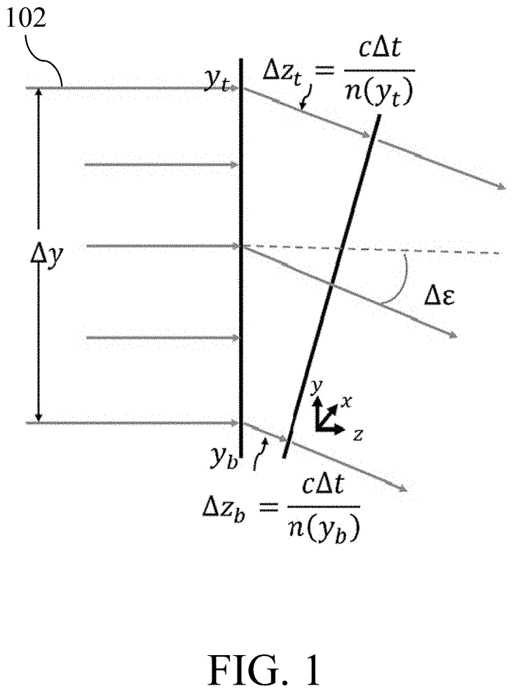

The basic principle behind the Schlieren technique is the deviation of light rays by optical heterogeneities in a transparent material that is not directly detected by the human eye. Optical heterogeneities arise due to the variation in refractive index (n) in the material medium. Refractive index variation in material causes the light rays to refract and deviate from their straight-line path with a deflection angle depending on the localized refractive index gradient. This light deviation creates localized regions of brightness or darkness depending on which way the light rays deviate. In an optically homogeneous and stable material, all the light rays bend at the same angle, which results in a uniform intensity throughout the material. From a simple geometrical analysis for the light rays (102) bending as shown in FIG. 1, the following expression for the angle of deflection is obtained:

$$Δϵ = \frac{Δ {z}_{t} - Δ {z}_{b}}{Δ y} = \frac{\frac{c}{n ( {y}_{t} )} - \frac{c}{n ( {y}_{b} )}}{Δ y} Δ t$$

Substituting Δt=Δzn₀/c, where n₀ is a reference refractive index (usually refractive index of surrounding and c is the speed of light in vacuum),

$$Δϵ = \frac{{n}_{0}}{n ( {y}_{t} ) n ( {y}_{b} )} \frac{n ( {y}_{t} ) - n ( {y}_{b} )}{Δ y} Δ z$$

(“Equation 2”) is obtained. By taking the limit that the differential distances approaching zero, and approximating n₀/n(yₜ)n(y_{b}) by 1/n₀,

$$\frac{\partial ϵ}{\partial z} = \frac{1}{{n}_{0}} \frac{\partial n}{\partial y}$$

(“Equation 3”) is obtained. Integrating the above differential equation provides the deflection angle at each y location. Therefore,

$${ϵ}_{y} = \frac{1}{{n}_{0}} \int \frac{\partial n}{\partial y} dz . \qquad ( “ Equation 4 ” )$$

The deflection angle can be calculated in x direction, ∈ₓ by simply replacing y with x in Equation 4. For a two-dimensional (2D) gradient in the xy plane,

$${ϵ}_{y} = \frac{1}{{n}_{0}} \frac{\partial n}{\partial y} L$$

(“Equation 5”) is obtained, and

$${ϵ}_{x} = \frac{1}{{n}_{0}} \frac{\partial n}{\partial x} L , \qquad ( “ Equation 6 ” )$$

where L is the pathlength of the light through the sample. This concludes the discussion on the Schlieren principle.

In the following Section II, an all-lens schlieren system is discussed along with methods to measure sample heterogeneity. Thereafter, the effect of protein concentrations on the refractive indices of protein solutions are discussed in Subsection III(A), followed by the quantitative validation of the described systems and methods by measuring diffusion coefficients for known solutions (glycerol and salt, respectively) in Subsection III(B). Finally, in Subsection III(C), the heterogeneities induced in thawing samples are visualized using the Schlieren methods described showing that the heterogeneities increase with increasing the concentration of the samples.

### II. EXEMPLARY SCHLIEREN-BASED SYSTEMS AND METHODS

A. Portable Schlieren-Based System Architecture

The refractive index in any region of a transparent fluid sample depends on the local density, and the density is a function of temperature and chemical composition. Temperature or concentration variations lead to density variations, resulting in changes in the refractive index in any transparent medium. In the instance of uniform temperature, the refractive index is solely a function of concentration. The refractive index variation is directly related to the concentration variation (c) in a sample by Equation 7, where a and b are constants depending on the solution components. By measuring the optical heterogeneities, the concentration variations in a sample can be quantified:

n=αc+b (“Equation 7”).

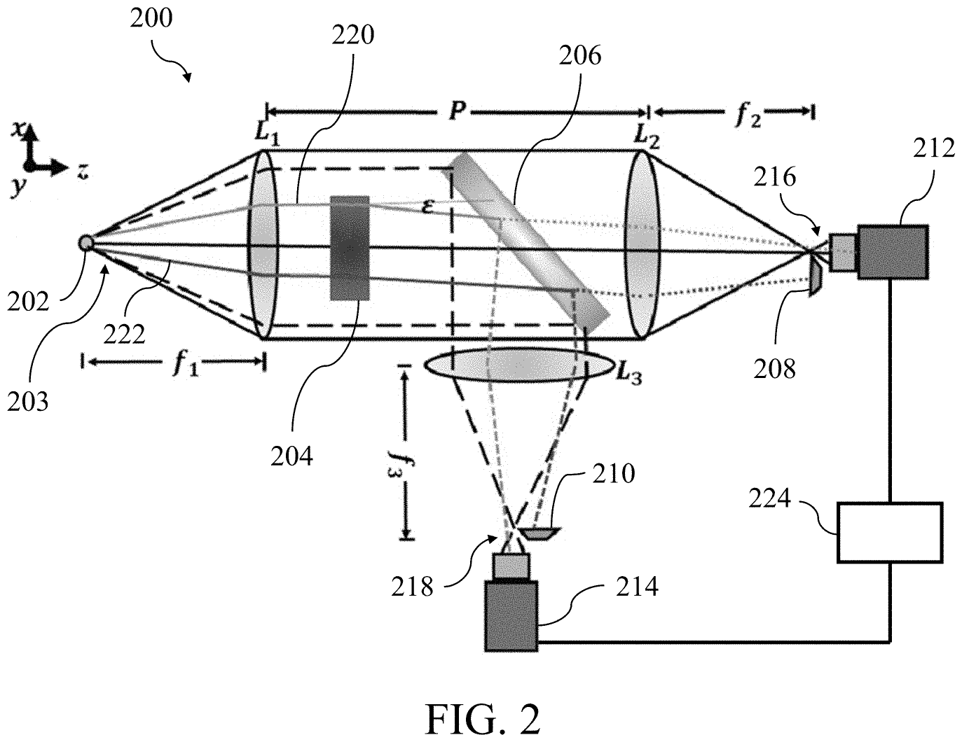

Shown in FIG. 2 is a schematic of one exemplary system (200) which utilizes the schlieren principle to visualize heterogeneities in therapeutic samples. An EDGELEC pre-wired SMD LED is used as a point light source (202) that emits a light beam (203), in some embodiment which is white light, although other similar light sources may be utilized with the system a point light sources. The light from the point source (202) is made parallel by passing it through a collimating lens (L₁) defining a focal length (f₁). The parallel beam of light then travels through the test sample (204), where the light rays are deflected. The deflected light then passes through a beam-splitter (206), which is configured to split the deflected light into two or more portions, and finally a first portion of the light passes through a first condensing lens (L₂) defining focal length (f₂) and a second portion of the light passes through a second condensing lens L₃ defining focal length (f₃). First and second condensing lenses (L₂, L₃) are each configured to focus their respective light portions onto a respective obstruction, such as knife edge (208, 210). Both the lenses (L₂, L₃) used may be, in one embodiment, achromatic with a two-inch diameter where f₁ ranges from approximately 70-130 mm, f₂ ranges from approximately 150-250 mm, and f₃ ranges from approximately 150-250 mm. In particular embodiments, f₁ is 100 mm, f₂ is 180 mm, and f₃ is 180 mm. Further, in some embodiments, high-speed cameras (212, 214) may be utilized to detect the respective light signals (216, 218) not blocked by the knife edges (208, 210). In some examples, Imperx CLM-B6640M-TF000 cameras may be utilized with 85 mm focal length lenses for capturing images. In some embodiments, a processing device (224) may be coupled with the cameras (212, 214) process the images recorded by each camera (212, 214), for example, to correlate the images and configured to receive the first and second images and generate an output report indicative of the heterogeneity of the test sample.

Knife-edge (208) cuts the received image at the focal point (f₂) of the first condensing lens (L₂) to improve the contrast of the image by partially blocking deflected light, while knife-edge (210) cuts the received image at the focal point (f₃) of the second condensing lens (L₃) to improve the contrast of the image by partially blocking deflected light. Depending on the orientation of the knife-edge (208), gradients may be measured in concentration in the x or y directions using a vertical or horizontal knife edge, respectively. In order to simultaneously measure both spatial gradients, the beam (203) is split by the beam splitter (206) coming out of the sample (204) by using a 50:50 beam-splitter. The solid and dashed lines in FIG. 2 show the path of light rays originating from the beam (203). Certain rays are deflected along different pathways. For example, a first ray (220) is deflected such that it is not blocked by the knife edges (208, 210) and goes directly into the cameras (212, 214) resulting in a bright intensity within the image. On the other hand, a second ray (222) is deflected such that it is blocked by the knife-edges (208, 210) reducing its intensity in the images recorded by cameras (212, 214).

It should be understood that, while analysis of the x and y (i.e., the horizontal and vertical) gradients of samples are illustrated by FIG. 2 and described herein, these are only two examples of knife edge orientations that may be utilized and sample gradients that may be analyzed. Knife edges (208, 210) may instead be oriented along any possible orientation to view the gradients in any direction of the sample (204). For example, knife edges (208, 210) may be oriented along any two non-parallel planes, whether the two planes are orthogonal or otherwise.

B. Calibration of the Portable Schlieren-Based System Architecture

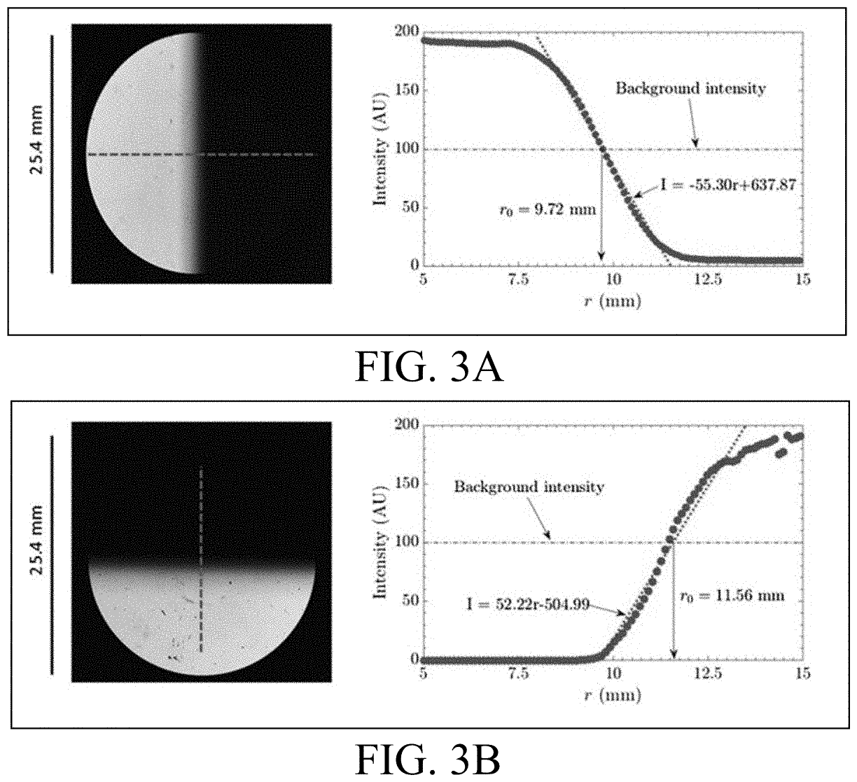

A weak lens may be utilized for calibrating the system (200). A weak lens is a lens with a long focal length, such that it produces deflection angles within the range of interest for the Schlieren disturbances to be visualized. In one example, a lens of diameter 25.4 mm and focal length of 5 mm may be used. The light rays passing through the center are not deflected, while the light rays passing at a distance equal to the radius of the weak lens are deflected the most. This gives rise to a change in light intensity inside the weak lens from darkest to brightest from one end to the other. The intensity between the two ends varies gradually from the darkest to the brightest, as shown in FIGS. 3A and 3B. Particularly, FIG. 3A shows the intensity variation (where AU refers to arbitrary units) in a weak lens along the diameter (i.e., the dashed line in the lefthand lens depiction) when the knife-edge is disposed vertically. For the purposes of calibration, a linear variation of intensity can be assumed within the weak lens shown by a dotted linear fit in the intensity-versus-r plots. Point r₀ depicts the position where the intensity matches the intensity of the surrounding reference sample. FIG. 3B shows the intensity variation in a weak lens along the diameter (i.e., the dashed line in the lefthand lens depiction) when the knife-edge is disposed horizontally. As illustrated by FIGS. 3A and 3B, a vertical knife-edge detects horizontal concentration gradients, and a horizontal knife-edge detects vertical concentration gradients. Note that the gradation from darkest to brightest intensity is present only if the light rays are cut by a knife-edge, as explained in the previous subsection. By calibrating the intensity change within the knife-edge cut, the pixel intensity can be correlated with the deflection angle.

Any ray passing through the lens at a distance r will hence be refracted by an angle:

$$tan ϵ \approx ϵ = \frac{r}{f} , \qquad ( “ Equation 8 ” )$$

where f is the focal length of the weak lens. The calibration process starts by identifying a location in the weak lens where the intensity is equal to the reference uniform background intensity (r₀ as shown in FIG. 3). This point acts as a baseline for all the deflection angle measurements. The deflection angle for this point in the weak lens is Ex. To calculate the deflection angle at any point in the sample image, we need to first identify the position inside the weak lens where the intensity value is equal to the intensity value at that point in the sample image. We denote this position as r. The deflection angle at the point of interest is then equal to,

$${ϵ}_{x} = ϵ - {ϵ}_{0} = \frac{r - {r}_{0}}{f} . \qquad ( “ Equation 9 ” )$$

The concentration gradient can be calculated using Equations 6, 7 and 9 as:

$$\frac{\partial c}{\partial x} = \frac{{n}_{0}}{a L} \frac{r - {r}_{0}}{f} . \qquad ( “ Equation 10 ” )$$

This procedure is followed for calculating the y gradient using a horizontal knife-edge.

C. Sensitivity Analysis of the Portable Schlieren-Based System Architecture

A sensitivity analysis on the above equation provides,

$$Δ ( \frac{\partial c}{\partial x} ) = \frac{{n}_{0}}{a L} \frac{Δ ( r - {r}_{0} )}{f}$$

(“Equation 11”), where A is the change in the corresponding quantities. From the data presented in the next subsection, the minimum concentration gradient detected can be calculated by the Schlieren system architecture described above. The resulting sensitivity is approximately 1 μg/ml/mm for an 8-bit camera and a 2 mm thick cuvette. The maximum value of the concentration gradient detected depends on the position of the knife edge. Hence, it can be adjusted according to the range of concentration gradients seen in the sample under investigation. Thus, the proposed method is useful in a variety of samples with a wide range of antigens and buffer compositions.

D. Sample Preparation

This subsection presents the data on therapeutic proteins utilized in visualizing heterogeneities in thawing samples. Four different buffer solutions (see, Table 1 below) were used to prepare solutions of BSA and IgG. The samples were prepared with concentrations ranging from 1 μg/ml to 200 μg/ml. The samples were frozen by storing them in a freezer for a day at −10° C. in a 2 mm pathlength quartz cuvette. Then, the samples were thawed in the Schlieren system architecture by submerging them into a water bath at room temperature. This way, the thawing process could be visualized, and the heterogeneities detected during this process. All the measurements were performed for the samples from Table 1.

TABLE 1

| | | Antibody/Protein |
|---|---|---|
| Formulation | Matrix | Concentration (μg/ml) |
| A | DI water | BSA (1-200) |
| B | 1× saline (0.9% NaCl) | BSA (1-200) |
| C | 10 mM Histidine, 1× saline, 5% | BSA (1-200) |
| | sucrose | |
| D | 10 mM Histidine, 1× saline, 0.05 | BSA (1-200) |
| | Polysorbate 80 | |
| E | DI water | IgG (1-200) |
| F | 1× saline (0.9% NaCl) | IgG (1-200) |
| G | 10 mM Histidine, 1× saline, 5% | IgG (1-200) |
| | sucrose | |
| H | 10 mM Histidine, 1× saline, 0.05 | IgG (1-200) |
| | Polysorbate 80 | |

### III. EXPERIMENTAL RESULTS FOR ONE EXEMPLARY PORTABLE SCHLIEREN-BASED SYSTEM ARCHITECTURE

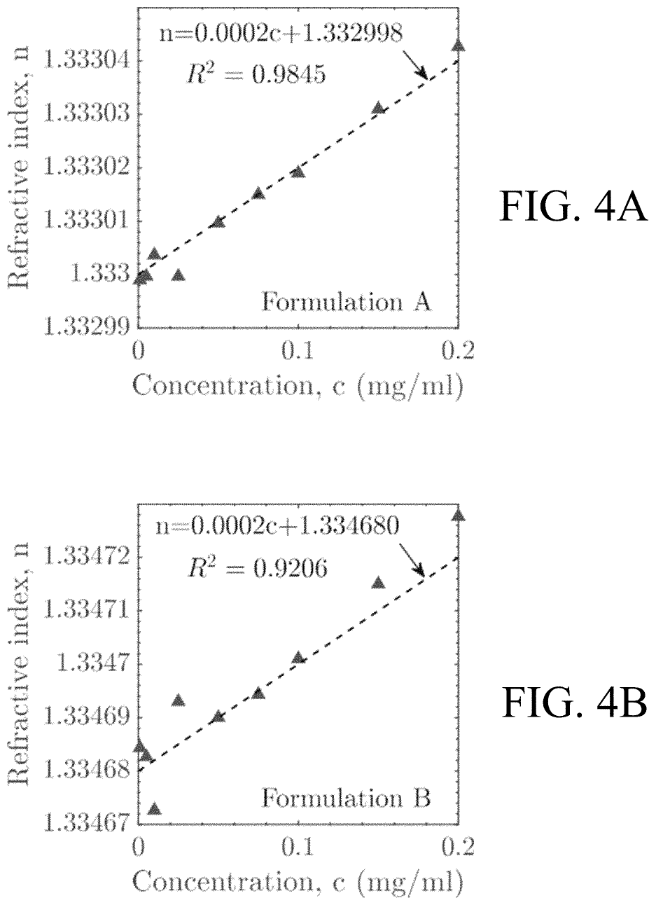

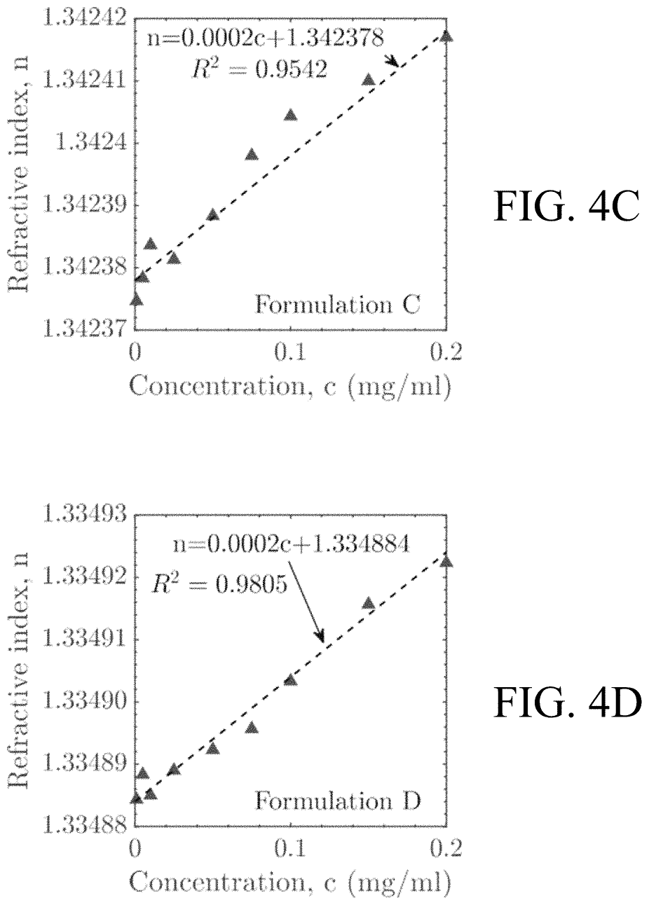

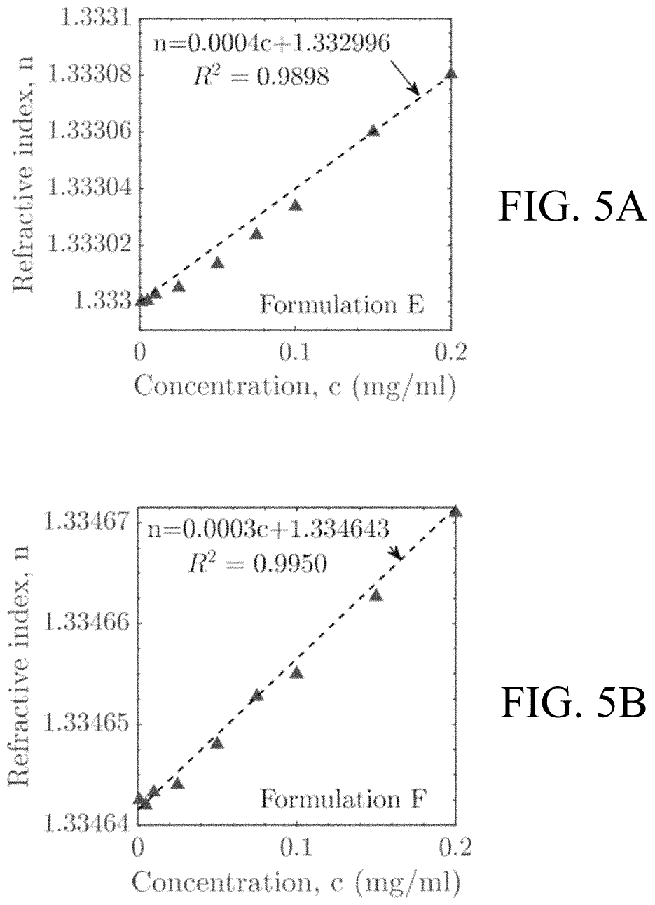

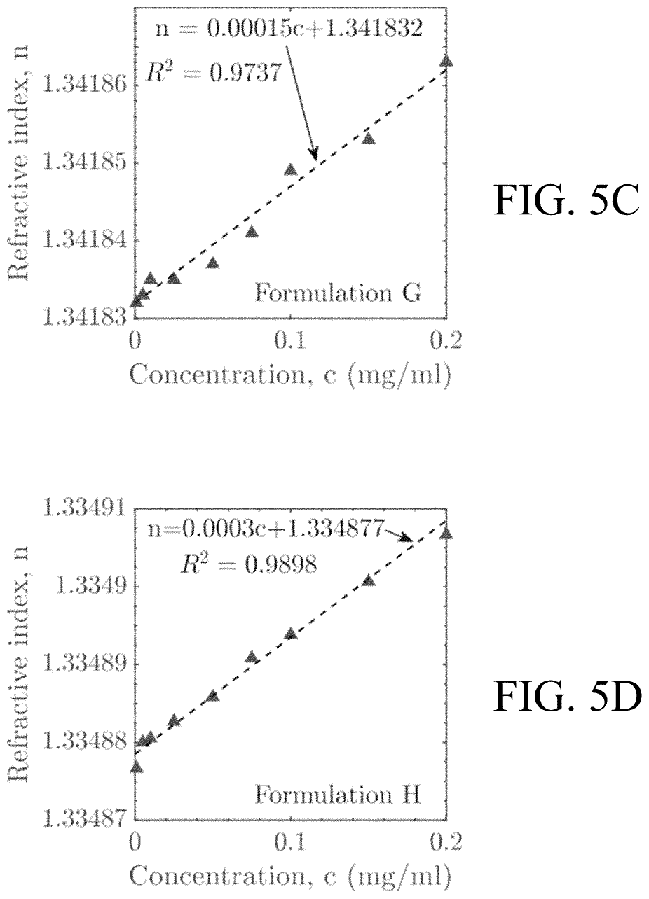

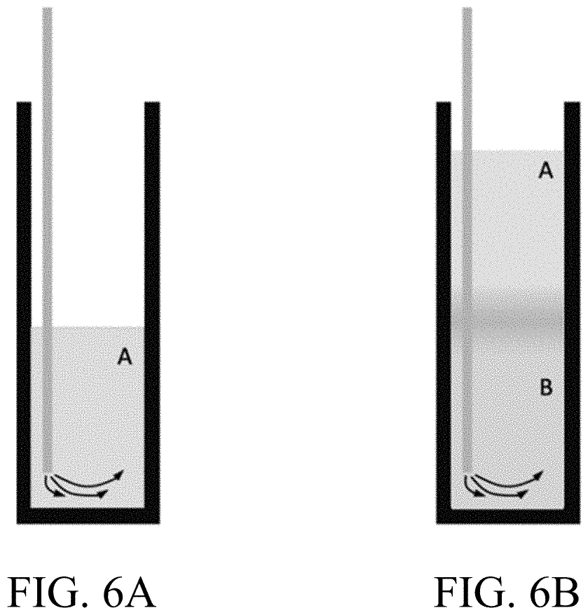

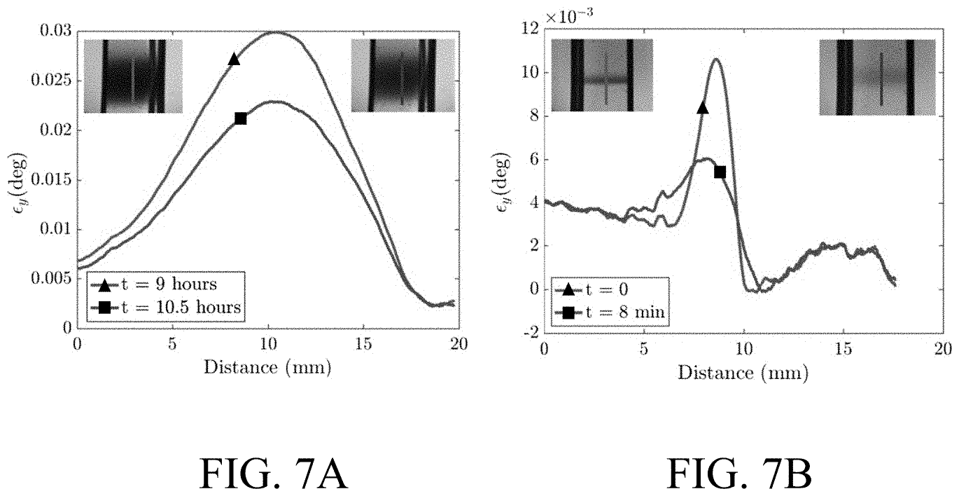

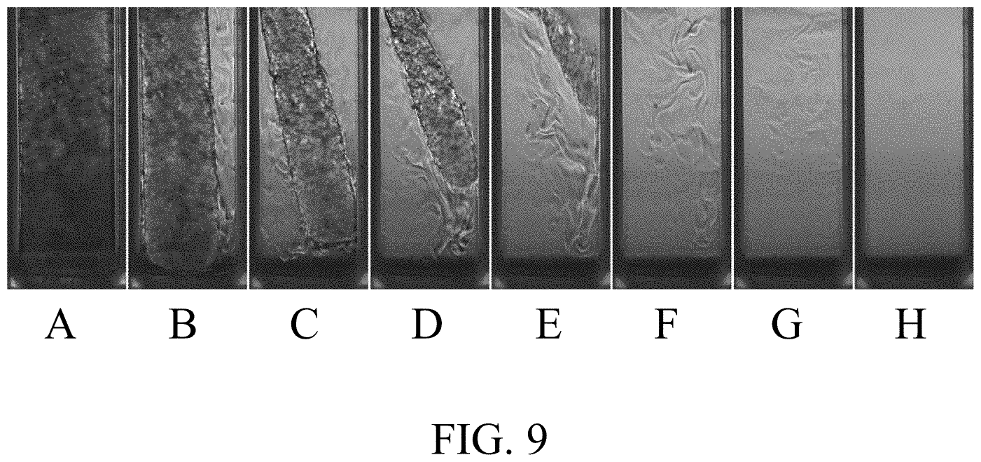

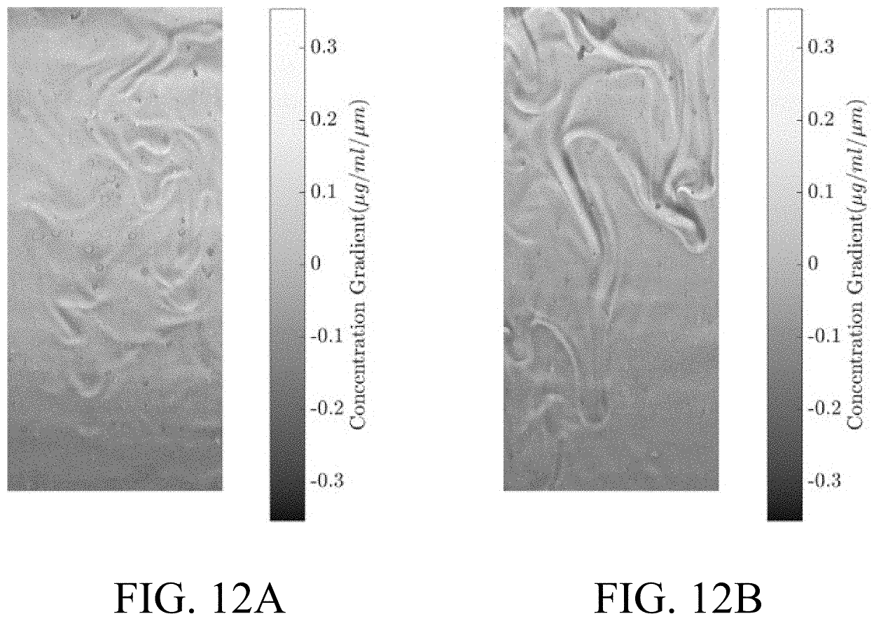

First, correlations between the refractive indices and concentration measurements are presented for all the formulations considered in Table 1 (see, FIGS. 4A-5D). Next, a quantitative validation of the described system architecture is provided by measuring diffusion coefficients for known solutions, glycerol, and salt, respectively (see, FIGS. 6A-7B). Then, snapshots of thawing IgG samples are provided for different time intervals, which show a visualization of the concentration gradients in the form of light intensity variations in the sample (see, FIGS. 9-11). Finally, the refractive index measurements and the calibration technique discussed above are utilized to quantify these heterogeneities in thawing samples (see, FIGS. 12A-12B). Shown is the accuracy and efficiency of the Schlieren-based system described herein. It should be noted that while proteins or antibodies (e.g., IgG and BSA) solutions are studied and described in detail herein, the described measurement technique is equally applicable to other therapeutic samples as well (e.g., antigens).

A. Refractive Index Dependence on Concentration

The refractive index is a linear function of the concentration at a constant temperature. However, this relationship should be quantified for the calibration process. Hence, the refractive indices are measured of all the samples by a refractometer. The particular refractometer utilized for the experimentation described herein provides significant sensitivity of 0(10⁻⁴ nD). In order to ensure that the obtained data is statically accurate, the measurements were repeated ten times for each sample and the mean value reported.

The measurements for BSA formulations A-D are shown in FIG. 4 and for the IgG formulations E-F in FIG. 5. These results show that the refractive index varies linearly with concentration and the change in refractive index is significant even for a small change in concentration. Thus uniformity (or non-uniformity) of the refractive index in a sample of interest directly correlates to the sample homogeneity (or heterogeneity). A linear fit is used to the measured data to obtain the constants a and b in Equation 7 for each formulation in Table 1 above. The results of this fitting are shown as dashed lines in the corresponding n vs. c plots of FIGS. 4 and 5. Extracting small amounts of the solutions at different locations within the sample of interest can be used to obtain information about the sample heterogeneity. This method, however, can be intrusive, time-consuming, laborious, and can provide a low spatial resolution. One of the advantages of this method is that the sensitivity is around (10⁻⁴ nD), which corresponds to a detectable change of around 5 μg/ml in concentration. Thus, the proposed method based on Schlieren visualization is superior to these direct measurements as a continuous concentration gradient field is obtained that can be quantified and even be seen with naked eye as is demonstrated in the following subsections.

Even though the refractive index depends on both concentration and temperature, the changes in temperature may only affect the bias of the refractive index with respect to concentration. Thus, the refractive index gradient (∂n/∂c) remains constant with respect to temperature changes for aqueous solutions. One solution is to measure the refractive index for changes in concentration and temperature of electrolyte, polar, non-polar, and protein solutions. Findings from that solution indicate that the gradient (∂n/∂c) remains constant through different temperatures, and thus the quantification of concentration gradients during freeze-thaw processes is possible using the system and method described herein. Subsection III(C) shows no refractive index variations within a thawing distilled water (since there are no concentration gradients) sample even though there may be significant temperature gradients.

B. Validation by Diffusion Coefficient Measurement

As a means of validation for the experimental system setup, the diffusion coefficients of select samples were measured using the following system setup. A sharp stratification was created between a solution of known concentration at the bottom and water at the top and the diffusion process was visualized using the Schlieren architecture described herein. To create the interface between the two fluids, a cuvette was slowly filled from the bottom up to prevent or restrict any mixing. The less dense solution, in this case, water, was injected first (see, FIG. 6A), followed by the denser solutions (see, FIG. 6B). The concentrated solution was injected slowly below the water to make sure that the convection effects were negligible. This ensured that the solution layers were stably stratified (see, FIG. 6B). In addition, the diffusion coefficient calculations were performed after the formation of the interface so that the effects of the initial transients die down. This process is illustrated in FIGS. 6A and 6B.

The samples selected for this purpose consisted of a 1% w/v salt solution and a 50% v/v glycerol solution. These samples were chosen because they exhibit different time scales for the interface diffusion process due to their diffusion coefficient difference. It should be understood these samples were chosen merely for experimentation and are not intended to be limiting. Whereas the salt-water solution takes minutes to diffuse, glycerol can take hours and even days for complete diffusion. The diffusion process can be mathematically represented using Fick's second law, which is a differential equation governing the evolution of the concentration field. The one-dimensional diffusion process between two fluids is governed by,

$$\frac{\partial c ( y , t )}{\partial t} = D \frac{{\partial }^{2} c ( y , t )}{\partial {y}^{2}} . \qquad ( “ Equation 12 ” )$$

Here c(y, t) is the concentration field in the vertical direction in the cuvette and D is the mutual diffusion coefficient The solution to this equation is found to be,

$$c ( y , t ) = \frac{{c}_{0} - {c}_{1}}{2} + \frac{{c}_{0} - {c}_{1}}{2} {e}^{\frac{y}{2 \sqrt{D t}}}$$

(“Equation 13”) for two fluids, with subscripts of 0 and 1 respectively, separated at y=0 with D being the mutual diffusion coefficient for the system. This solution can be re-written in terms of the refractive index gradients by using the linear relation Equation 7 between n and c as:

$$\frac{\partial n ( y , t )}{\partial y} = \frac{{n}_{0} - {n}_{1}}{2 \sqrt{π D t}} {e}^{- \frac{{y}^{2}}{4 D t}} . \qquad ( “ Equation 14 ” )$$

Here n_{0,1} are the refractive indices of the top and the bottom fluids.

Finally, using Equation 6, Equation 14 can be expressed in terms of the deflection angle as

$${ϵ}_{y} = L \frac{{n}_{0} - {n}_{1}}{2 \overline{n} \sqrt{π D t}} {e}^{- \frac{{y}^{2}}{4 D t}} . \qquad ( “ Equation 15 ” )$$

Here, n̅ is the average refractive index, n̅=(n₀+n₁)/2 and L is the light path length through the sample, which is the same as the cuvette thickness.

Images of the diffusing interface were captured every thirty seconds for the saltwater solution and sixty seconds for the glycerol solution using the Schlieren-based system setup to solve for the diffusion coefficient. The pixel intensity across the diffusing interface was tracked over time after the initial unwanted transients, caused by the convective effects from injecting the concentrated sample, died down. Using this intensity data and the calibration process discussed in subsection II(B), the deflection angle (∈∈_{y}) caused by the concentration gradient across the interface was calculated. The time evolution of the deflection angle throughout an extracted line as shown in the insets of FIGS. 7A and 7B was calculated. FIGS. 7A and 7B show an example of the deflection angle at a time frame for both solutions, respectively. Specifically, FIG. 7A depicts a graphical representation of a calculated deflection angle over a line of interrogation for 50% v/v Glycerol, where the width of the deflection profiles reflect the extent of diffusion across the interface and the inset shows the interface at the initial time (left) and final time (right). Further, FIG. 7B depicts a graphical representation of a calculated deflection angle over a line of interrogation for 1% w/v Salt in water, where the width of the deflection profiles reflect the extent of diffusion across the interface and the inset shows the interface at the initial time (left) and final time (right). Equation 15 is used to calculate the diffusion coefficient, D, from the deflection angle measurements.

Equation 15 can be rewritten as

$${ϵ}_{y} = L \frac{{n}_{0} - {n}_{1}}{2 \overline{n} \sqrt{π D t}} {e}^{- \frac{{y}^{2}}{4 D t}} = A ( t ) {e}^{- \frac{{y}^{2}}{B ( t )}}$$

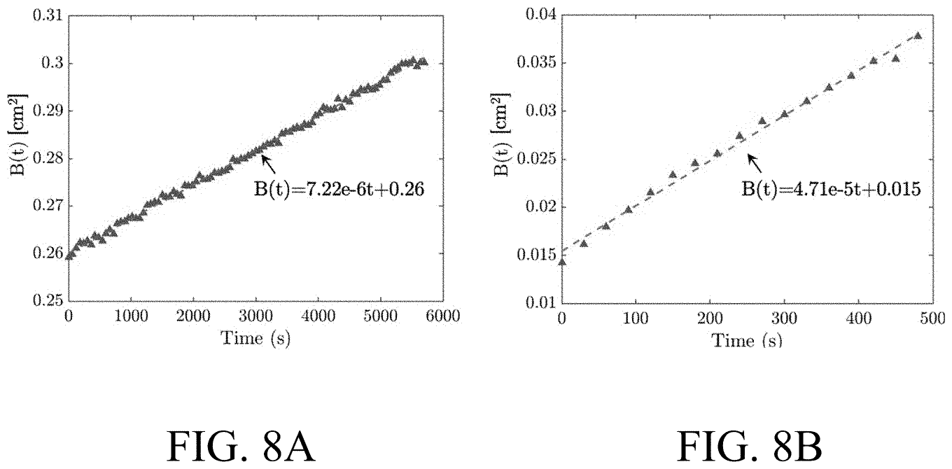

(“Equation 16”), where A(t)=L(n₀−n₁)/2\sqrt{πDt} and B(t)=4Dt. The deflection angle can be found as a function of the position at every time step by using the least squares method. By calculating for the coefficient B(t), one can solve for the diffusion coefficient simply by taking the derivative of this coefficient with respect to time, dB/dt=4D. The expected relationship should be linear, as the diffusion coefficient is constant. This was the case for both diffusion cases, as shown FIGS. 8A and 8B, respectively. Specifically, FIG. 8A shows experimental measurements for coefficient B(t) vs time, t, for 50% v/v Glycerol, and FIG. 8B shows experimental measurements for coefficient B(t) vs time, t, for 1% w/v Salt in water. As expected from Equation 16, B(t) increases linearly with time. The dotted lines in each of FIGS. 8A and 8B depict a linear square fit to B(t) vs. t data. The slope of this linear fitting gives the diffusion coefficient since dB(t)/dt=4D.

By using this method, various factors from the diffusion process can be disregarded, such as the initial time when diffusion starts as well as the refractive indices of the samples and the background. This method yielded diffusion coefficients of D=1.18×10⁻⁵ cm²/s and D=1.80×10⁻⁶ cm²/s for the saltwater and glycerol solutions, respectively. These values agree with previous experiments with calculated diffusion coefficients of D=1.48×10⁻⁵ cm²/s and D=3.37×10⁻⁶ cm²/s, respectively. Deviations from these values might come from initial mixing, as well as different experimental conditions such as the temperature of the samples.

C. Heterogeneity in Thawing Samples

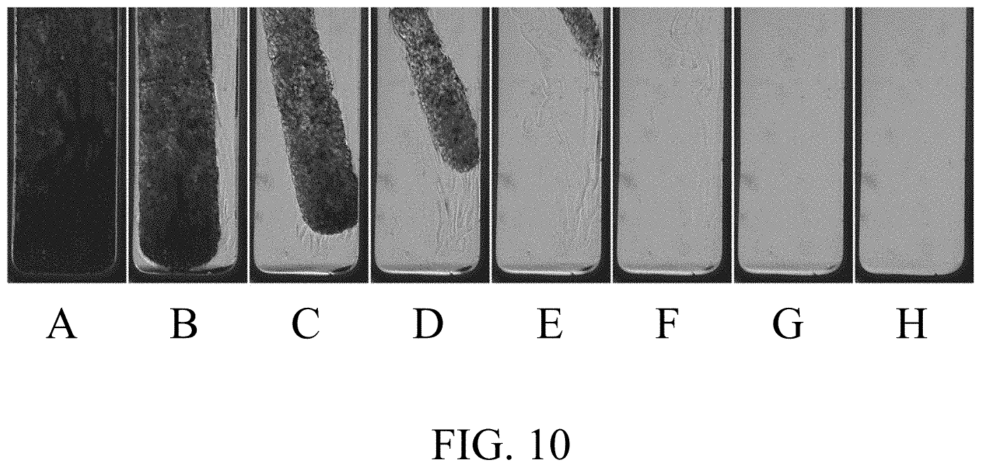

In this subsection, the visualization of the thawing process of a 5 μg/ml and a 50 μg/ml of IgG samples (formulation F) are presented to demonstrate the capabilities of the Schlieren-based system setup. The visualizations are presented for both the vertical (see, FIGS. 9A-9H) and horizontal (see, FIGS. 10A-10H) concentration gradients, which are detected by using vertical and horizontal knife-edges (e.g., knife edges 208, 210), respectively. Regarding FIGS. 9A-9H, the output images demonstrate that the heterogeneities induced during the thawing of samples and the mixing can be visualized using the Schlieren technique. Particularly, FIG. 9A was taken at t=0 seconds, FIG. 9B was taken at t=50 seconds, FIG. 9C was taken at t=75 seconds, FIG. 9D was taken at t=90 seconds, FIG. 9E was taken at t=100 seconds, FIG. 9F was taken at t=110 seconds, FIG. 9G was taken at t=120 seconds, and FIG. 9H was taken at t=200 seconds. Regarding FIGS. 10A-9H, the output images demonstrate that the heterogeneities in the horizontal direction are negligible. Particularly, FIG. 10A was taken at t=0 seconds, FIG. 10B was taken at t=50 seconds, FIG. 10C was taken at t=75 seconds, FIG. 10D was taken at t=90 seconds, FIG. 10E was taken at t=100 seconds, FIG. 10F was taken at t=110 seconds, FIG. 10G was taken at t=120 seconds, and FIG. 10H was taken at t=200 seconds.

Regarding FIGS. 9A-10H, it should be noted that the images are preprocessed to remove artifacts caused by imperfections in the optical path and the occasional appearance of bubbles or dust within the region of interest. Since most of the artifacts are static, the reference image (i.e., the image in which the samples are at the equilibrium state) is first subtracted from all the images in the time series. Then, outlier pixel intensities were detected using a 2D moving median filter and replaced with a linear interpolation of nearest non-outlier pixel values. Finally, to recover the original pixel intensities, the reference image was preprocessed and added to all images post outlier removal. The preprocessing of the reference image was done using an outlier removal followed by a Wiener filter.

The samples were first frozen to −10° C. and were allowed to thaw by keeping them in a water bath at room temperature. As the samples thaw, the heterogeneities can be seen as caused by concentration gradients. Two samples of formulation F were thawed with concentrations of 5 μg/ml and 50 μg/ml. As can be observed from FIGS. 9A-9H and FIGS. 10A-10H, even for a low concentration, thawing can introduce heterogeneity which is easily detected by the Schlieren-based system and method. The heterogeneities are dominant in the vertical direction compared to that in the horizontal direction. This is because the heterogeneity manifests itself in the local density variations and hence a buoyancy force in the vertical direction. As a result, the concentration gradients are stronger in the vertical direction as compared to the horizontal direction.

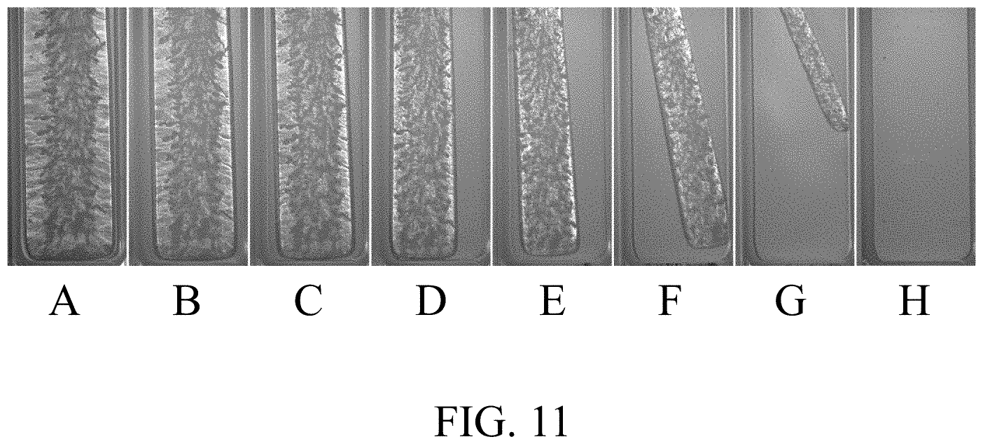

FIGS. 11A-11H illustrate the thawing process for frozen distilled water. Snapshots at specific time intervals are presented from FIG. 11A through FIG. 11H. Particularly, FIG. 11A was taken at t=0 seconds, FIG. 11B was taken at t=20 seconds, FIG. 11C was taken at t=45 seconds, FIG. 11D was taken at t=80 seconds, FIG. 11E was taken at t=100 seconds, FIG. 11F was taken at t=110 seconds, FIG. 11G was taken at t=150 seconds, and FIG. 11H was taken at t=200 seconds. The knife-edge is cutting horizontally, so any vertical gradients should be visible. As shown, however, there is little to n₀ evidence of heterogeneity for distilled water. Thus, the heterogeneities observed in the thawing protein samples are primarily due to the different thawing rates for the dissolved proteins. To delineate the effects of each buffer component on the heterogeneity, one can prepare various samples by varying only one component (e.g., the sugar or salt concentration). By doing this, the concentration gradient can be affected by one component of the buffer solution. However, deconvoluting the influence of each solution component is not possible from just a single sample visualization as the refractive index is a net outcome of all the solution components.

Finally, FIGS. 12A and 12B illustrate the concentration gradients quantified using the calibration process discussed in subsection II(B). The corresponding color bar gives the value of concentration gradients at different locations. The magnitude of these heterogeneities increases the concentration of the thawing samples is increased to 50 μg/ml (see, FIGS. 12A and 12B). Higher concentration results in a higher heterogeneity. Thus, the proposed technique is not only capable of visualizing heterogeneities but can also accurately quantify them. These results also demonstrate the applicability of the proposed technique in analyzing the mixing processes for monitoring the quality of therapeutic solutions and vaccines.

The developed Schlieren-based systems and methods provide many advantages compared to existing techniques used for analyzing heterogeneity in therapeutic samples and vaccines. For example, the systems and methods described herein are significantly faster to fractionating the sample or withdrawing small amounts from the sample at different locations as these methods cannot provide continuous concentration variations in the entire sample. In addition, the Schlieren-based systems and methods are easily portable as they have a decreased number of components which are readily available and affordable as compared to existing systems and methods. The described system can be, for example, 1 foot wide by 3 feet long, making it suitable for in-line installation. Furthermore, depending on the sample size to be analyzed (e.g., in a small cuvette as is the case in this study or a large vessel), the system setup can be easily miniaturized or enlarged by simply changing the apertures and focal lengths of the lenses used (e.g., lenses L₁, L₂, and/or L₃). Many samples can be analyzed at the same time and provide immediate qualitative and quantitative feedback. The sensitivity can be easily improved if needed using lenses with a larger aperture. The proposed technique can even be more accurate than interferometric and deflectometric techniques, as an additional degree of sensitivity is present with the pixel intensity, which can be improved using a camera with a higher bit depth.

The presented validation and demonstrations from the Schlieren-based system and method establish the potential of the techniques to be used as a process analytical technology (PAT) for continuous manufacturing. The described systems and methods are non-intrusive and overcome the constraints presented in existing systems and methods. Further, the described systems and methods may be readily employed in various settings and provide real-time feedback without altering existing processes or requiring expensive equipment.

### IV. CONCLUSION

As described in detail above, refractive index and Schlieren-based systems and methods were provided to advantageously detect mixing in thawing therapeutic samples. Given the dependence of the refractive index on the concentration and composition of the therapeutic solutions, it is possible to detect and quantify heterogeneity in samples using their refractive indices. The Schlieren-based system and method provides a simple yet powerful tool to non-intrusively detect heterogeneities (as low as 1 μg/ml/mm) in protein samples by placing them between two appropriate lenses. The described system is easier to set up as compared to existing systems and improves the sample mixing monitoring and control in the manufacturing, storage, and usage of therapeutic solutions or patient samples.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A system, comprising:
(a) a light source configured to emit a light beam;
(b) a first lens configured to collimate the light beam, wherein the first lens is configured to direct the collimated light beam through a test sample;
(c) a second lens;
(d) a third lens;
(e) a beam splitter configured to split the light beam from the test sample, wherein the beam splitter is configured to transmit a first portion of the light beam toward the second lens and reflect a second portion of the light beam toward the third lens;
(f) a first image collection device positioned adjacent to a first obstruction, wherein the first image collection device is configured to record a first image formed by the first portion of the light beam, wherein the first obstruction is configured to partially obstruct the first portion before the first portion is recorded by the first image collection device; and
(g) a second image collection device positioned adjacent to a second obstruction, wherein the second image collection device is configured to record a second image formed by the second portion of the light beam, wherein the second obstruction is configured to partially obstruct the second portion before the second portion is recorded by the second image collection device.

2. The system of claim 1, wherein the first obstruction is a first knife defining a first knife edge, wherein the second obstruction is a second knife defining a second knife edge, wherein the second lens is configured to focus the first portion onto the first knife edge, wherein the third lens is configured to focus the second portion onto the second knife edge.

3. The system of claim 2, wherein the first and second image collection devices define x-y planes, wherein:
the first knife edge is arranged in an x-direction defined parallel to the x plane with respect to the first image collection device, wherein the first image collection device is configured to detect concentration gradients perpendicular to the x-direction of the test sample; and
the second knife edge is arranged in a y-direction defined parallel to the y plane with respect to the second image collection device, wherein the second image collection device is configured to detect concentration gradients perpendicular to the y-direction of the test sample.

4. The system of claim 2, wherein the first and second image collection devices define common x-y planes relative to each other, wherein:
the first knife edge is arranged along a first plane relative to the x-y plane of the first image collection device; and
the second knife edge is arranged along a second plane relative to the x-y plane of the second image collection device;
wherein the first plane is non-parallel to the second plane relative to the x-y planes defined by the first and second image collection devices.

5. The system of claim 2, wherein the first knife edge is configured to cut the first portion of the light beam at a first focal point defined by the second lens, wherein the second knife edge is configured to cut the second portion of the light beam at a second focal point defined by the third lens.

6. The system of claim 1, wherein the first lens defines a first focal length from 70-130 millimeters.

7. The system of claim 1, wherein the second lens defines a second focal length from 150-250 millimeters.

8. The system of claim 1, wherein the third lens defines a third focal length from 150-250 millimeters.

9. The system of claim 1, wherein the second and third lenses are condensing lenses.

10. The system of claim 1, wherein the second and third lenses are achromatic.

11. The system of claim 1, wherein the beam splitter is a 50/50 beam splitter.

12. The system of claim 1, further comprising a data processing device configured to receive the first and second images and output a report indicative of a heterogeneity of the test sample.

13. The system of claim 1, wherein the light source is a point light source configured to emit a white light beam.

14. A method of analyzing a therapeutic test sample with an optical system, wherein the optical system includes a light source, a first lens, a beam splitter, a second lens, and a first image collection device, the method comprising:
(a) generating a light beam from the light source;
(b) directing the light beam through the first lens and through the therapeutic test sample;
(c) transferring a first portion of light from the test sample through the second lens;
(d) obstructing, at least partially, the first portion of the light from the second lens; and
(e) recording, via the first image collection device, a first image from the at least partially obstructed first portion of light.

15. The method of claim 14, wherein the optical system includes a third lens and a second image collection device, the method further comprising:
(a) transferring a second portion of light from the test sample through the third lens;
(b) obstructing, at least partially, the second portion of the light from the third lens; and
(c) recording, via the second image collection device, a second image from the at least partially obstructed second portion of light.

16. The method of claim 14, wherein the test sample includes a tube defining a vertical height and a horizontal width, the method further comprising measuring a first concentration of the therapeutic test sample along the vertical height and a second concentration of the therapeutic test sample along the horizontal width.

17. The method of claim 14, wherein obstructing the first portion of the light from the second lens includes partially blocking the first portion of light using a knife edge.

18. The method of claim 14, further comprising generating a report indicative of a heterogeneity of the therapeutic test sample.

19. A method of calibrating an optical system for analyzing a therapeutic test sample, wherein the optical system includes a light source configured to emit a light beam, a first lens, a beam splitter, a second lens, and a first image collection device, the method comprising:
(a) emitting a light beam toward a weak lens;
(b) identifying a location in the weak lens where an intensity value of the light beam is equal to a reference uniform background intensity;
(c) identifying a position inside the weak lens where the intensity value of the light beam is equal to an intensity value of a sample image at a common point of reference of the therapeutic test sample and the sample image;
(d) calculating a deflection angle of the light beam using the identified position inside the weak lens where the intensity value of the light beam is equal to the intensity value of the sample image at the common point of reference; and
(e) calculating a concentration gradient of the therapeutic test sample.

20. The method of claim 19, wherein calculating the deflection angle of the light beam includes using the formula: ∈ₓ=∈−∈₀=r−r₀/f, where r denotes the position inside the weak lens where the intensity value of the light beam is equal to the intensity value of the sample image at the common point of reference.
